(19) United States
(12) Patent Application Publication
(10) Pub. No.: US 2005/0206032 A1
(43) Pub. Date: Sep. 22, 2005

(54) Preparation method of polymer solution

(75) Inventors: Seiichi Ono, Kanagawa (JP); Yuji Suzuki, Kanagawa (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/084,096

(22) Filed: Mar. 21, 2005

(30) Foreign Application Priority Data
Mar. 22, 2004 (JP) 2004-083381

(51) Int. Cl. B29C 39/14

(52) U.S. Cl. 264/216; 264/349

(57) ABSTRACT

A TAC, a solvent, and additives are supplied into a mixing tank to obtain a mixture liquid, which is fed to a heating device by a pump for heating to 90° C. Then the mixture liquid is fed through a first static mixer to obtain a lower concentration dope. Since being prepared by feeding through the first static mixer, the lower concentration dope is excellent in uniformity. Then the lower concentration dope is heated under a high pressure, and then discharged in to a flash tank. Thus the lower concentration dope is enriched to a higher concentration dope, which is fed out from the flash tank. After the control of the temperature, the higher concentration dope is fed through a second static mixer to be uniform.

### BACKGROUND OF THE INVENTION

1. Field of the Invention

The present invention relates to a preparation method of polymer solution.

2. Description Related to the Prior Art

Cellulose acylate is used for forming a film. Especially a cellulose triacetate film (hereinafter TAC film) is formed from a cellulose triacetate (hereinafter TAC) having degree of acetylation in the range of 57.5% to 62.5%, and is used as a film base, such as photosensitive materials, because of strength and nonflammability. Further, since having an excellent optical isotropy, the TAC film is used as an optical compensation film and a protective film for a polarizing filter in a liquid crystal display whose market becomes wider.

The TAC film is usually produced by a solution casting method, in which the produced film having a superior physical properties such as the optical properties to films produced by other film producing methods, such as an extrusion method and the like. In the solution casting method for producing the TAC film, a mixture solvent whose main compound is dichloromethane or methyl acetate is prepared, and the TAC is dissolved to the mixture solvent, such that a polymer solution (hereinafter dope) may be obtained. The dope is cast on a polished metallic support by a casting die, so as to form a casting film. When having a self-supporting property, the casting film is peeled from the metallic support, and transported with drying by a tenter dryer and transporting devices such as rollers.

Since the dissolubility of the TAC to the solvent is not high. Therefore the preparation of the dope from the TAC as the polymer becomes hard. For example, if it is designated to prepare the dope whose polymer concentration is in the range of 20 wt. % to 30 wt. %, the polymer does not enough dissolve even with being stirred, and therefore undissolved materials remain. Accordingly, after a dilute dope having a low concentration (hereinafter lower concentration dope) is previously prepared, and then enriched to be a higher concentration dope. There are several known methods of enriching the dope, as described below. An organic solvent is supplied into a mixer which is disposed with an inclination. While the organic solvent is fed and cooled in the mixer, the polymer is added to and swollen in the organic solvent. As described in Japanese Patent Laid-Open Publication No. 11-323017, in an exit side of the mixer, the swollen polymer containing part of the organic solvent is separated through a mesh structure of a separator from other part of the solvent which has not contained in the polymer. Thus the concentration of the polymer is increased. Further, a flash evaporation method is described in the Japanese Patent Laid-Open Publication No. 2001-40031. In the flash evaporation method, the polymer solution is sprayed in upper side in a flash drum with use of a feed nozzle, a part of the solvent in the solution is evaporated. Solvent vapor is discharged from the flash drum through a discharging line, and the convection of the enriched polymer solution is made in a lower side of the flash drum, and discharged with use of a gear pump. Furthermore, as shown in U.S. Pat. Nos. 2,541,012 & 4,414,341, the dissolution of the polymer is enriched to have a predetermined concentration in the range of 20 wt % to 30 wt. %.

In the enriching method disclosed in the publication No. 11-323017, the swollen polymer particles contain part of the solvent are separated from the other solvents which are not contained in the polymer particles. Therefore, if the dope is prepared by dissolving the polymer to the organic solvent, the polymer solvent removed, which causes the loss of the dope. Further, in the swelling process of the polymer, a reproducibility is bad, and it is hard to keep the composition of the polymer in the mixture constant.

In the flash evaporation method in the publication No. 2001-40031, a wall of a flash tank is heated above the boiling point of the solvent. The polymer solution is adhered to the wall, the polymer as the solute often remains on the wall. Further, around the feed nozzle, a plate (or skirt) is attached, and when the polymer solution is sprayed, the spread of the misty polymer solution is reduced. However, when the polymer solution is adhered to the skirt and the solvent is evaporated, some polymer remains as foreign material at several positions. When the foreign materials on the wall and the skirt fall into the higher concentration dope in the convection, the film produced from the dope has defects.

In the method as described in the publications U.S. Pat. Nos. 2,541,012 & 4,414,341, the solute such as the polymer is mixed to a recovery solvent. Thereafter, in a dehydration process, when the moisture content is adjusted with use of a distillation column, the solute such as the polymer is precipitated to stop the flow. Further, when the flash evaporation is made, the non-uniformity of the polymer concentration of the dope and the gel causes the generation of impurities, which is called the skinning to make the quality of the dope lower. Further, blades of stirrer for stirring the dope in the flash tank rotate to increase the temperature of the dope. In this case, the temperature of the dope sometimes becomes higher than the predetermined value and therefore the evaporation and the enriching are made too much.

### SUMMARY OF THE INVENTION

An object of the present invention is to provide a preparation method of a polymer solution in which foreign materials such as the gel-like materials and the skinning are not contained after a enriching.

In order to achieve the object and the other object, in a preparation method of a polymer solution the present invention, a polymer is dissolved to the solvent with a heating, such that a dilute polymer solution is obtained. The concentration of the dilute polymer solution is in the range of 15 wt. % to 20 wt. %. The dilute polymer solution is filtrated, such that the polymer concentration of the dilute polymer solution may be regulated in the range of (predetermined concentration)±1 wt. %. Then the dilute polymer solution is enriched so as to obtain a polymer solution whose concentration is in the range of 20 wt. % to 30 wt. %. Thereafter the polymer solution is filtrated. Thus the polymer concentration of the polymer solution after the enriched is reduced in the range of ±1 wt. % 1 wt. % from a predetermined concentration. Further, the heating is made by a heat exchanger, and a static mixer for stirring the dilute polymer solution is disposed downstream from the heat exchanger before the filtration.

In a preferable embodiment of a preparation method of a polymer solution of the present invention, the polymer is dissolved to the solvent with a heating at a temperature equal to or more than a boiling point of the solvent, such that the dilute polymer solution is obtained. The polymer concentration of the dilute polymer solution is in the range of 15 wt. % to 20 wt. %. The dilute polymer solution is supplied into a vessel in which a pressure is controlled to (atmospheric pressure)±0.01 MPa. The dilute polymer solution is enriched to be a polymer solution whose polymer concentration is in the range of 20 wt. % to 30 wt. %. Preferebly, the dilute polymer solution is stirred with stirrer blades provided in the vessel, and a height L1 (mm) from a top of each stirrer blade to a liquid surface of the dilute polymer solution is at most 800 mm. A rotary speed of the stirrer blades is from 2.5 rpm to 25 rpm.

Preferably, the vessel is provided with a pipe for supplying the dilute polymer solution therein, and a height L2 (mm) from a liquid surface of the dilute polymer solution to an exit of the pipe is in the range of 100 mm to 1000 mm. A heating unit is constructed of the heat exchanger and the static mixer disposed in downstream from the heat exchanger, and a number of the heating unit is at least 2. A temperature of the dilute polymer solution in each of the static mixer is increased by at least 20° C. and at most 70° C.

solvent vapor generated in the enriching is liquidized for recovery, so as to reuse for preparing the polymer solution. Further, the vessel is connected through a pipe to a liquidizing device for liquidizing the solvent vapor with aspirating the solvent vapor. A height L3 (mm) from a liquid surface of the dilute polymer solution to an entrance into the pipe is in the range of 200 mm to 1000 mm. A temperature of the dilute polymer solution in the vessel is kept to a predetermined value in the range of 30° C. to 40° C.

Preferably, a temperature T (° C.) of the dilute polymer solution before supplied to the vessel is in the range of 60° C. to 120° C. When a theoretical value of vapor pressure at the temperature T is P0 (MPa) and a coefficient determined corresponding to a sort of the solvent is A (MPa/° C.), a pressure P (MPa) of the dilute polymer solution to be supplied to the vessel is controlled so as to satisfy a formula, 2.0 MPa>P(MPa)≧(P0+(T−40)×A)MPa. The heating is made by a heat exchanger, and a static mixer for stirring the dilute polymer solution is disposed downstream from the heat exchanger.

Preferably, a heat exchanger is disposed downstream from the vessel, and a temperature of a heat transfer medium of the heat exchanger is in the range of 30° C. to 40° C. A filtration apparatus for filtrating the polymer solution is disposed downstream from the vessel, and includes a filter whose nominal pore diameter is from 3 μm to 100 μm.

In still another preferable embodiment of a preparation method of a polymer solution of he present invention, the polymer is dissolved to the solvent with heating at a temperature equal to or more than a boiling point of the solvent by a heat exchanger, such that a dilute polymer solution is obtained. A polymer concentration of the mixture polymer solution is in the range of 15 wt. % to 20 wt. % the dilute polymer solution is stirred with use of a static mixer, and then enriched to a polymer solution whose polymer concentration is in the range of 20 wt. % to 30 wt. %. Preferably, a heating unit is constructed of the heating exchanger and the static mixer disposed in downstream from the heat exchanger. A number of the heating unit is at least 2, and a temperature of the dilute polymer solution becomes by at least 20° C. and at most 70° C.

Preferably, a flow rate of the dilute polymer solution to be fed to the static mixer is from 30 L/min to 150 L/min, and a diameter of a pipe of the static mixer is from 50 mm to 200 mm. a number of a skirt provided in the static mixer is from 4 to 20. The heat exchanger is a spiral heat exchanger. The polymer solution is used for producing a polymer film, and at least 60 wt. % of the polymer film is formed of the polymer solution.

According to the preparation method of the present invention, after the dilute polymer solution whose polymer concentration is in the range of 15 wt. % to 20 wt. % is prepared, the enriching of the dilute polymer solution is made such that the polymer content may be in the range of 20 wt. % to 30 wt. %. Therefore, the period for preparing the polymer solution becomes shorter, and the polymer solution having higher concentration can be produced. Further, the polymer solution having higher concentration is preferably used for the solution casting method.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is an explanatory view of an embodiment in which a preparation method of polymer solution of the present invention is applied;

FIG. 2 is an exploded view of a flash tank used in the embodiment in FIG. 1;

FIG. 3 is an explanatory view of another embodiment in which a preparation method of polymer solution of the present invention is applied;

FIG. 4 is a schematic diagram of an embodiment of a solution casting method in which the polymer solution is used.

### PREFERRED EMBODIMENTS OF THE INVENTION

The polymers used in the present invention are not especially restricted. Further, in the cellulose ester, it is preferable to use cellulose acylate, particularly to use cellulose acetate. In the cellulose acetate, it is especially preferable to use cellulose triacetate (TAC) whose averaged acetyl value is from 57.5% to 62.5% (degree of substitution is from 2.6 to 3.0). The acetyl value means an acetylation degree in mass of acetic acid combined to be a cellulose acetate molecule. The acetyl value is obtained in accordance with the method for measuring and calculating the acetylation degree in ASTM:D-817-91 (testing method for cellulose acetate and the like).

In the cellulose acylate to be used in the present invention, the degree of the substitution preferably satisfies all of the following formulae (I)—(III):
2.5≦A+B≦3.0 (I)
0≦A≦3.0 (II)
0≦B≦2.9 (III)

In these formulae, A is a degree of substitution of the hydrogen atom to the acetyl group, and B is a degree of substitution of the hydrogen group to the acyl group having 3-22 carbon atoms.

In an embodiment of the present invention, the cellulose acylate particles may be used. At least 90 wt. % of the cellulose acylate particles has diameter from 0.1 mm to 4 mm, preferably from 1 mm to 4 mm. Further, it is preferable that the ratio of the cellulose acylate particles having diameter from 0.1 to 4 mm is preferably at least 95 wt. % of the cellulose acylate particles, particularly at least 97 wt. %, especially at least 98 wt. %, and most especially at least 99 wt. %. Furthermore, it is preferable that at least 50 wt. % of the cellulose acylate particles have diameter from 2 mm to 3 mm. The ratio of the cellulose acylate particles having diameter from 2 mm to 3 mm is particularly at least 70 wt. %, especially at least 80 wt. %, and most especially at least 90 wt. %. Preferably, the cellulose acylate particle has a nearly ball-like shape.

As the solvent used in the present invention, there are, for example, aromatic hydrocarbons, halogenated hydrocarbon, esters, ketones, ethers, and alcohols. The solvent is not restricted, so far as having the purity of the compounds in the market. The solvent to be used in the present invention may be a single or a mixture solvent. In the case of the mixture solvent, the solvent may contain halogenated hydrocarbons, esters, ketones, ethers, and alcohols. Concretely, in the halogenated hydrocarbon, there are, for example, dichloromethane, and the like. In the esters, there are, for example, methyl acetate, methyl formate, ethylacetate, amylacetate, butylacetate and the like. In ketones, there are, for example, acetone, methylethylketone, cyclohexanone and the like. In ethers, there are, for example, dioxane, dioxolane, tetrahydrofrane, diethylether, methyl-t-butylether, methyl cellosolve, and the like. In alcohol, there are, for example, methanol and ethanol, n-butanol. Note that if it is designated to used a mixture solvent as the solvent, the preferable main solvent compounds are dichloromethane and methylacetate.

The halogenated hydrocarbon whose each molecule has 1 to 7 carbon atoms is preferably used, and dichloromethane is used the most preferably. In view of physical properties, such as the dissolubility of the TAC and peelability from the support, a mechanical strength and optical properties of the film and the like, not only the dichloromethane but also an alcohol whose each molecule has carbon atoms from one to five is mixed to the solvent. In this case, the content of the alcohol is preferably in the range of 2 wt. % to 25 wt. %, and particularly 5 wt. % to 20 wt. As the alcohols, concretely, there are methanol, ethanol, n-propanol, isopropanol, n-butanol, and the like, and among them, methanol, ethanol n-butanol and the mixture of them are preferably used.

Recently, in order to reduce the influence on the environment, the solvent containing no dichloromethane is proposed. In this case, the solvent contains ethers with 4 to 12 carbon atoms, ketones with 3 to 12 carbon atoms, esters with 3 to 12 carbon atom, or a mixture of them. The ethers, ketones, esthers may have a cyclic structure, and compounds having at least two functional groups thereof (—O—, —CO—, —COO—) are used as the organic solvent. In this case, the number of carbon atoms may be at most the predetermined values for each compound of the functional group.

As the additives to be added to the dope, there are plasticizer, UV-absorbing agent, matting agent (for example silicon dioxide, zirconium dioxide, and the like), fluorinated type surfactant, peeling agent (for example, amino acid, carboxylic acid and the like), deteoriation inhibiter (for example, amines, aromatic basic compound), retardation controller (for example aromatic compound containing aromatic hydrocarbon ring and aromatic hetero ring), oil gelation agent and the like. However, the sorts of the additives are not restricted in them. Note that the addition of the additives may be made when or after the polymer is dissolved to the solvent. Further, the solution in which the additives are dissolved to the solvent may be added to the solvent for the dope or the dope. In this case, the addition is made in a batch manner, or continuously made in an inline manner.

As the plasticizers, for example, there are phosphoric acid esters (for example, triphenyl phosphate (herein after TPP), tricresylphosphate, cresyldiphenyl phosphate, octyldiphenyl phosphate, diphenylbiphenyl phosphate (hereinafter BDP), trioctyl phosphate, tributyl phosphate and the like), phthalic acid esters (for example, diethyl phthalate, dimethoxyethyl phthalate, dimethyl phthalate, dioctyl phthalate, and the like), glycolic acid esters (for example, triacetin, tributyrin, butylphthalylbutyl glycolate, ethylphthalylethyl glycolate, methylphthalylethyl glycolate, butylphthalyl butylgricolate and the like), and other plasticisers.

The cellulose acylate is described in detail in the Japanese patent application No. 2003-319673, and the description of this publication can be applied to the present invention. Further, as the solvent of cellulose acylate and other additives, this publication discloses plasticizers, deteoriation inhibitor, optical anisotropy controlling agent, dye, matting agent, peeling agent are in detail.

Ultraviolet absorptive agents to be used in the cellulose acylate film of the present invention will be explained. The cellulose acylate film of the present invention is used in the liquid crystal monitor or a polarizing filter on account of the high dimensional stability. In this case, in view of the prevention of deterioration of the polarizing filter and the liquid crystal display, the ultraviolet absorptive agents are preferably used in view of preventing deterioration of the liquid crystal. The preferable ultraviolet absorptive agent is the compound which effectively absorbs ultraviolet ray under 370 nm of wave length, and hardly absorbs visible ray above 400 nm of wave length in view of indication probability of the liquid crystal. For example, there are oxybenzophenone compounds, benzotriazol compounds, salycilic acid ester compounds, bensophenone compounds, cyanoacrilate compounds, nickel complex salt compound, and the like. Particularly preferable are benzotriazol compounds and benzophenone compounds.

Concretely, the benzotriazol type ultraviolet absorbing agent will be described below. However, the present invention is not restricted especially. For example, there are 2-(2′-hydroxy-5′-methylphenyl)benzotriazol; 2-(2′-hydroxy-3′,5′-di-tert-butylphenyl)benzotriazol; 2-(2′-hydroxy-3′-tert-butyl-5′-methylphenyl)benzotriazol; 2-(2′-hydroxy-3′-tert-butyl-5′-methylphenyl)benzotriazol; 2-(2′-hydroxy-3′,5′-di-tert-butylphenyl)-5-chlorobenzotriazol; 2-(2′-hydroxy-3′-(3″,4″,5″,6″-tetrahydrophthalimido methyl)-5′-methylphenyl)benzotriazol; 2,2-methylenebis(4-(1,1,3,3-tetramethylbutyl)-6-(2H-benzotriazol-2-il)phenol); 2-(2′-hydroxy-3′-tert-butyl-5′-methylphenyl)-5-chlorobenzotriazol; 2,4-dihydroxybenzophenone; 2,2′-dihydroxy-4-methoxybenzophenone, 2-hydroxy-4-methoxy-5-sulfobenzophenone, bis(2-methoxy-4-hydroxy-5-benzoilphenylmethane), 2,4-bis-(n-octylthio)-6-(4-hydroxy-3,5-di-tert-butylanylino)-1,3,5-triadine; 2(2′-hydroxy-3′,5′-di-tert-butylphenyl)-5-chlorobenzotriazol; 2(2′-hydroxy-3′,5′-di-tert-amylphenyl)-5-chlorobenzotriazol, 2,6-di-tert-butyl-p-crezol, pentaerythrityl-tetrakis[3-(3,5-di-tert-butyl-4-hydroxyphenyl)propionate]; triethylene glycol-bis[3-(3-tert-butyl-5-methyl-4-hydroxyphenyl)propionate]; 1,6-hexanediol-bis[3-(3,5-di-tert-butyl-4-hydroxyphenyl)propionate], 2,4-bis-(n-octylthio)-6-(4-hydroxy-3,5-di-tert-butylanilino)-1,3,5-triadine; 2,2-thio-diethylenebis[3-(3,5-di-tert-butyl-4-hydroxyphenyl)propionate], octadecyl-3-(3,5-di-tert-butyl-4-hydroxyphenyl propionate), N,N′-hexamethylenebis(3,5-di-tert-butyl-4-hydroxy-hydrocineamide), 1,3,5-trimethyl-2,4,6-tris(3,5-di-tert-butyl-4-hydroxybenzyl)benzene, tris-(3,5-di-tert-butyl-4-hydroxybenzyl)-isocianurate and the like. Especially preferable are 2,4-bis-(n-octylthio)-6-(4-hydroxy-3,5-di-tert-butylanylino)-1,3,5-triadine; 2(2′-hydroxy-3′,5′-di-tert-butylphenyl)-5-chlorobenzotriazol; (2(2′-hydroxy-3′,5′-di-tert-amylphenyl)-5-chlorobenzotriazol, 2,6-di-tert-butyl-p-crezol, pentaerythrityl-tetrakis[3-(3,5-di-tert-butyl-4-hydroxyphenyl)propionate]; triethylene glycol-bis[3-(3-tert-butyl-5-methyl-4-hydroxyphenyl)propionate]. Further, for example, the following compound can be used simultaneously; metallic nonactivator of hydradine type, such as N,N′-bis[3-(3,5-di-tert-butyl-4-hydroxyphenyl)propionyl]hydradine, processing stabilizers of phosphor type, such as tris(2,4-di-tert-butylphenyl)phosphite and the like. The added amount of these compound is preferably 1 ppm to 1.0% in mass ratio to cellulose acylate, and particularly 10 ppm to 1000 ppm.

Further, it is preferable to use the ultraviolet absorbing agent described in the Japanese Patent Laid-Open Publication No. 6-148430. The above UV-absorbing agent to be use in the present invention preferably has a high transparency, and a high effect of preventing the deterioration of liquid crystal element or the polarizing filter. It is especially preferable to use the UV-absorbing agent of the benzotriazol type which hardly makes the unnecessary coloring. The amount of the UV-absorbing agent to be used is varied depending on the sort of compounds and the conditions of use. However, the amount is usually from 0.2 g to 5.0 g in a 1 m² of cellulose acylate film, particularly from 0.4 g to 1.5 g, and especially from 0.6 g to 1.0 g.

Further, light stabilizers and UV-absorbing agents that are shown in a catalogue of “Adekastab” compendium of additives for plastic (Asahi-kaden) can be used. Further, SEESORB, SEENOX, SEETEC and the like that are shown in catalogue of SHIPRO KASEI KAISYA can be used. The UV-absorbing agents and the antioxidants of Johoku Chemical Co., Ltd. can be used. VIOSORB of Kyodo Chemical Co., Ltd. and the UV-absorbing agent of Yoshitomi Pharmaceut Ind., Ltd. can be used.

The Japanese Patent Laid-Open Publication No. 2003-043259 describes about a necessary spectral transmittance for producing the optical film, the polarizing filter, and the displaying device, which are excellent in color reproductivity and permanence against an irradiated UV-ray. The necessary spectral transmittance is from 50% to 95% of 390 nm UV-ray and the spectral transmittance of 350 nm UV-ray is at most 5%.

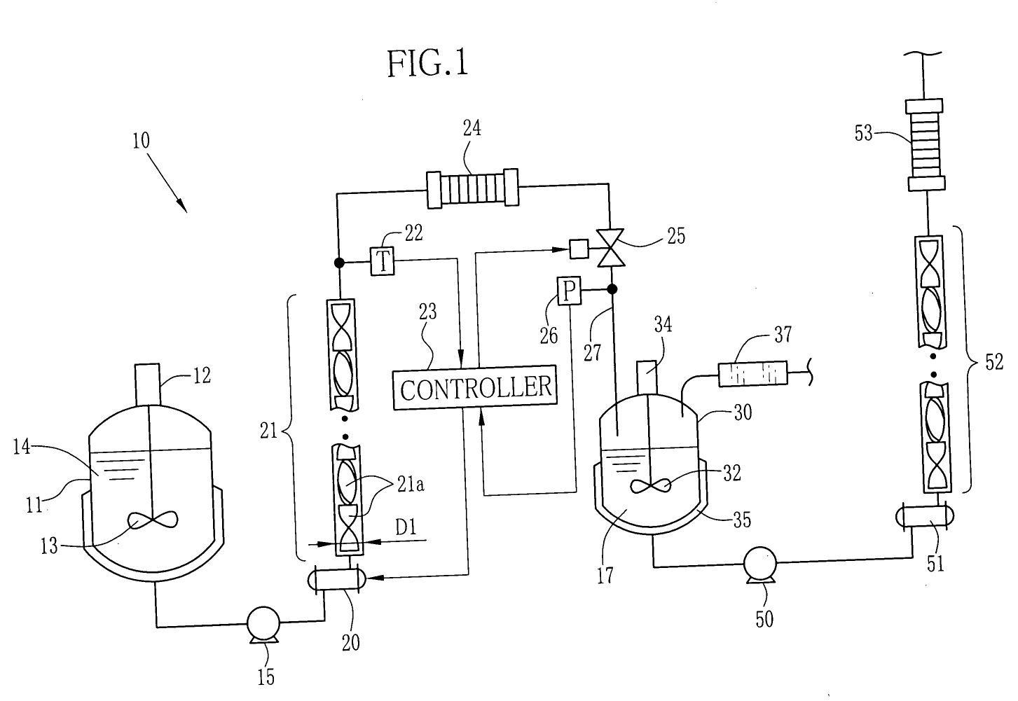

In FIG. 1, the polymer, the solvent and the predetermined additives are supplied into a mixing tank 11 of the dope preparation line 10. The mixing tank 11 includes stirrer blades 13 which are rotated by a motor 12. When the stirrer blades are rotated, the polymer, the solvent, and the additives are mixed, and thus a mixture liquid 14 is obtained. Note that the polymer concentration of the mixture liquid 14 is preferably in the range of 15 wt. % to 20 wt. %. If the polymer concentration is less than 15 wt. %, the concentration often does not become adequate value for the solution casting method even after enriching the dope. Further, since the dissolubility of the polymer (especially TAC) to the solvent is low, it takes a long time to prepare the dope having more than 20 wt % polymer concentration, and therefore the cost for the production becomes higher.

The flow rate of the mixture liquid 14 is controlled by operating a pump 15 and the mixture liquid 14 is fed to a heating device 20, which is preferably a heat exchanger. The sort of the heat exchanger is not restricted especially, and for example, there are multi-pipe cylindrical heat exchanger, plate type heat exchanger, spiral heat exchanger, a static mixer having a double tube structure, and the like. However, it is preferable to use the spiral heat exchanger which is excellent in efficiency of heat transfer and provides a complete countercurrent.

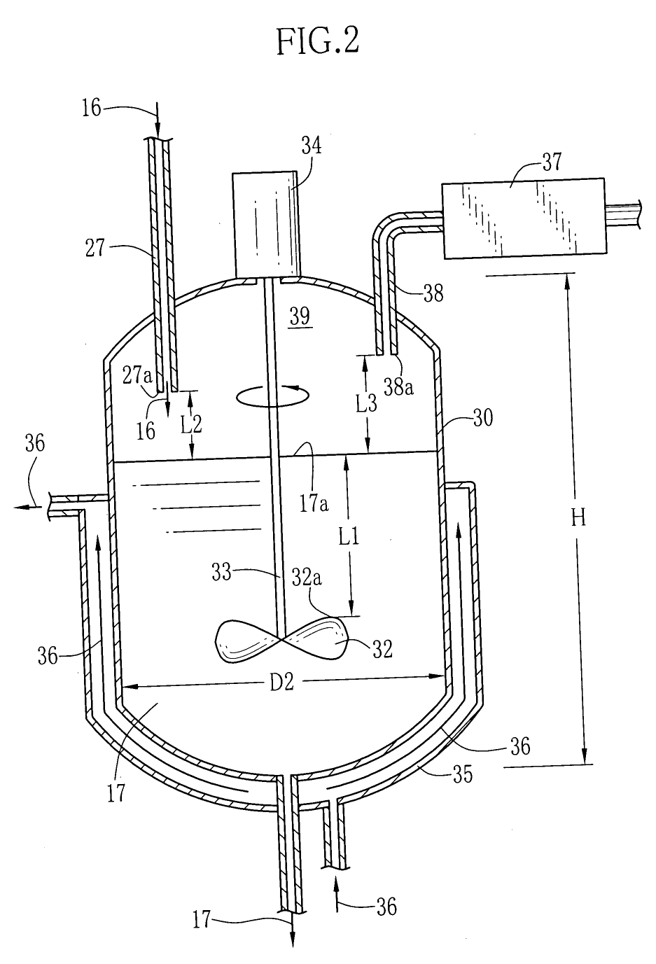

The mixture liquid 14 is heated by the heating device 20 so as to progress the dissolution. Thus a lower concentration dope 16 (see, FIG. 2) is obtained as a dilute polymer solution. Preferably, the lower concentration dope 16 is fed to a static mixer 21 for making the composition of the lower concentration dope 16 uniform. Then the temperature of the lower concentration dope 16 discharged from the static mixer 21 is measured by a thermometer 22, and the data of the measurement is set to a controller 23 for judging whether the temperature of the lower concentration dope 16 may be a predetermined value. If the temperature is not the predetermined value, the controller 23 sends the heating device 20 a signal for changing the heating conditions. For example, when the heat exchanger is used for the heating device 20, the temperature and the flow rate of the heating medium will be adjusted. The heating temperature of the lower concentration dope is at least a boiling point of the solvent.

The embodiment of the static mixer 21 is not restricted especially. As an example, the flow rate of the lower concentration dope 16 is preferably in the range of 30 L/min to 150 L/min, and especially in the range of 50 L/min to 80 L/min. An inner diameter D1 (mm) of tube of the static mixer 21 is preferably in the range of 50 mm to 200 mm, and especially in the range of 80 mm to 130 mm. The number of blades 21a is preferably from four to twenty, and especially from 4 to eighteen.

It is preferable to remove foreign materials from the lower concentration dope 16 for feeding the lower concentration dope 16 to a filtration apparatus 24. Thus the foreign materials hardly remains in a higher concentration dope 17 (a dope used for producing a film by the solution casting method) to be obtained by enriching the lower concentration dope 16. In the present invention, since the lower concentration dope 16 is stirred and mixed enough by the static mixer 21, only a small amount of the undissolved materials and the gel-like materials are contained. Therefore the filtration pressure hardly increases in performance of the filtration with use of the filtration apparatus 24. Note that even if the filtration apparatus 24 is disposed in the upstream side from the heating device 20, the foreign materials such as the undissolved materials and the gel-like materials are effectively removed. Thus, in this embodiment, since the heating conditions in the static mixer 21 are controlled and the filtration of the lower concentration dope 16 is made, the fluctuation of the polymer concentration is reduced in ±1 wt. %.

The lower concentration dope 16 is fed through a pressure adjusting valve 25 and a pressure of the lower concentration dope 16 is measured by a pressure gauge 26. A data of the pressure measurement is sent to the controller 23, which judges whether the measured pressure is the predetermined value necessary for a flash evaporation. Note that the pressure for the flash evaporation will be explained later. If the measured pressure is not the predetermined value, a signal is sent the pressure adjusting valve 25, and the pressure adjusting valve 25 opens and closes on the basis of the signal.

The lower concentration dope 16 whose temperature and pressure is controlled to the predetermined values is fed through a flash pipe 27 into a flash tank 30. Thereby, part of the solvent vaporizes from the lower concentration dope 16. Thus the concentration of the dope becomes larger, and the higher concentration dope having the concentration from 20 wt. % to 30 wt. % is stored in the flash tank 30. Note that the enriching method is explained in detail in the followings.

The higher concentration dope 17 is fed out from the flash tank 30 by operating a pump 50, and thereafter the temperature of the higher concentration dope 17 is controlled by a temperature controller 51. The temperature controller 51 is preferably a heat exchanger, and especially a spiral heat exchanger. Although a heat transfer medium is not restricted especially, it is preferably a hot water in view of cost. The temperature of the hot water is adequately adjusted depending on the solvent of the higher concentration dope 17. For example, the temperature is preferably from 30° C. to 40° C. when the dichloromethane type mixture solvent is used. Furthermore, the temperature is preferably from 20° C. to 50° C. when the methyl acetate type mixture solvent is used.

The higher concentration dope 17 is fed from the temperature controller 51 to a static mixer 52, which mixes and stirs the higher concentration dope 17 for the mixing, so as to make the concentration thereof uniform. Thereafter, the foreign materials, the undissolved materials and the gel-like materials are removed by a filtration apparatus 53. Also in this case, the higher concentration dope 17 is mixed by the static mixer 52 enough. The quantity of impurities, especially the gel-like materials, in the higher concentration dope 17 is extremely small, and the filtration pressure applied to the filtration apparatus 53 is reduced. Further, the higher concentration dope 17, from which the foreign materials such as the skinning, the undissolved materials and the like are removed enough, can be used as a dope for producing the film. A filter to be used for the filtration apparatus 53 is not restricted especially. In this embodiment, the fluctuation of the polymer concentration of the lower concentration dope is reduced, and thereafter the flash evaporation of the lower concentration dope, the heating of the higher concentration dope in the static mixer and the filtration of the higher concentration are made.

As described above, the higher concentration dope is obtained from the lower concentration dope in which the fluctuation of the polymer concentration is regulated in ±1 wt. % from the predetermined value. Therefore the fluctuation of the polymer concentration of the higher concentration dope is regulated in ±1 wt. %. However, the higher concentration dope 17 prepared by the preparation method of the dope of the present invention is used for the film production, the filter whose nominal pore diameter is from 3 μm to 100 μm is preferably used in order to remove the minute foreign materials.

As shown in FIG. 2, the higher concentration dope 17 is accumulated in the flash tank 30. The stirrer blades 32 are connected through a shaft 33 to a motor 34. The stirrer blades 32 rotate to stir the higher concentration dope 17. The flash tank 30 is provided with a jacket 35, and a heat transfer medium 36 is supplied between the flash tank 30 and the jacket 35. Further, in the upper part of the flash tank 30, the flash pipe 27 is provided, and the flash tank 30 is connected through a pipe 38 to a liquidizing device (condenser) 37.

A height L1 (mm) is a distance from a uppermost 32a of the stirrer blades 32 to a liquid surface 17a of the higher concentration dope 17, a height L2 (mm) is a distance from the liquid surface 17a to an exit end 27a of the flash pipe 27, and a height L3 (mm) is a distance from the liquid surface 17a to an entrance end 38a of the pipe 38. A capacity V (m³), a height H (mm), and a diameter D2 (mm) of the flash tank 30 is not restricted especially. However, preferably, the capacity V is from 3.0 m³ to 10.0 m³, H is from 1000 mm to 4000 mm, the diameter D2 is from 1000 mm to 3000 mm. During the drive in the steady state, the height L1 (mm) is preferably at most 800 mm, particularly at most 500 mm, and especially at most 300 mm. Further, during the drive in the steady state, the height L2 (mm) is from 100 mm to 1000 mm, and the height L3 (mm) is from 200 mm to 1000 mm. Furthermore, when a liquid phase volume V1 (m³) is a volume of the higher concentration dope 17, and a gas phase volume Vg (m³) is a volume of a space 39 above the higher concentration dope 17, a ratio Vl:Vg is preferably in the range of 4:6 to 9:1.

The heat transfer medium 36 is preferably a hot water. Note that the temperature of the heat transfer medium 36 is different between the solvents of the dope. For example, when the solvent is the dichloromethane type mixture solvent, the temperature is preferably in the range of 30° C. to 40° C., and when the solvent is the methylacetate type mixture solvent, the temperature is preferably in the range of 20° C. to 50° C. Further, the shape of the flush pipe 27 is not restricted in the figure, and may be for example a nozzle in which a front end portion becomes narrower or wider or a front end is cut aslant.

The lower concentration dope 16 is discharged from the flash pipe 27. In this case, it is preferable that a pressure P (MPa) of the lower concentration dope 16 satisfies a condition:
2.0 MPa>P (MPa)≧(P0+(T−40)×A)MPa (1)
Note that P0 (MPa) is a theoretical value of a vapor pressure that is calculated from the highest heating temperature T (° C.) of the lower concentration dope 16 during the heating. The temperature control of the heating device 20 is made such that the highest heating temperature T (° C.) may be from 60° C. to 120° C. Further, A (MPa/° C.) is a constant number determined depending on the sorts of the solvent. The constant number A is 0.01 (MPa/° C.) when the solvent is a dichloromethane type mixture solvent, and 0.008 (MPa/° C.) when the solvent is a methyl acetate mixture solvent.

When the lower concentration dope 16 is discharged toward the higher concentration dope 17, part of the lower concentration dope 16 vaporizes to be a solvent vapor in a gas-space. The solvent vapor is fed through the pipe 38 to the liquidizing device 37, which is cooled to liquidize the solvent vapor. In the point of the cost, it is preferable to use tha recovery solvent as the solvent for preparing the lower concentration dope 16. The cooling temperature of the enrichr is not restricted especially. However it is preferably from 0° C. to 30° C. when the solvent is a dichloromethane type mixture solvent, and 0° C. to 50° C. when the solvent is a methyl acetate mixture solvent. In order to make the uniform condensation, preferably, the difference of the inner pressure of the flash tank 30 from the atmospheric pressure is regulated in ±0.001 MPa.

The temperature of the higher concentration dope 17 is kept with use of the heat transfer medium 36, and the stirrer blades 32 stir the higher concentration dope 17 to keep the gas-liquid equilibrium to the solvent vapor in the gas phase space 39. Therefore, part of the solvent vapor is liquidized, and other part is fed through the pipe 38 to the liquidizing device 37 and liquidized. In order to keep the higher concentration dope in a steady state, the temperature adjustment is preferably made. Note that the rotary speed of the stirrer blade 32 is not restricted especially. However, it is in the range of 2.5 rpm to 25 rpm.

A shape of the stirrer blade 32 is not restricted especially. However, it may be an anchor type, a blue margin type, a turbine type, a spiral band type, a spiral shaft type, a propeller type, a paddle type, an inclined paddle type, a curved paddle, and max blend (trade mark; produced by Sumitomo Heavy Industries Ltd.).

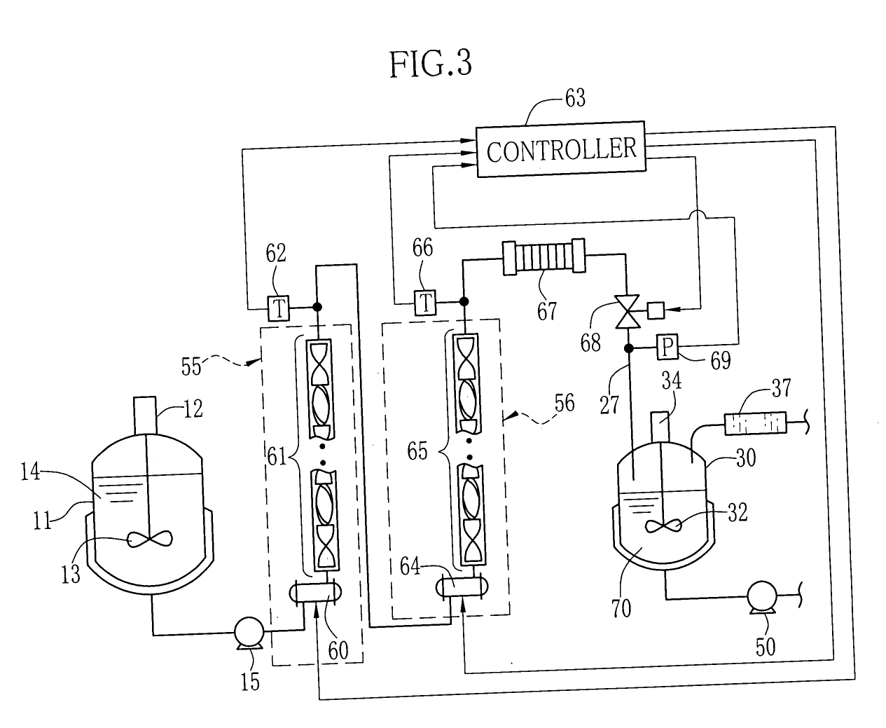

Another embodiment of the preparation method of the dope of the present invention is explained with reference to FIG. 3. Note that the same numerals are provided for the same parts and members as in the dope preparation line 10 in FIG. 1, and the explanation thereof is omitted. A heating unit 55 is constructed of a heating device 60 and a static mixer 61 disposed in downstream from the heating device 60. The mixture liquid 14 is fed to the heating device 60 by the pump 15, and thereafter to the static mixer 61 such that the concentration of the mixture liquid 14 may be uniform. When the mixture liquid is fed out from the static mixer 61, the temperature of the mixture liquid is measured by a thermometer 62, and the measured value is sent to a controller 63. The controller 63 judges whether the temperature is the predetermined value. If the temperature is not the predetermined value, a signal is sent to the heating device 60 to change the heating conditions.

Further, a heating unit 56 is constructed of a heating device 64 and a static mixer 65 disposed in downstream from the heating device 64. The mixture liquid is thereafter fed to the heating device 64 so as to further progress the heating such that the dissolution may be made enough. After the mixture liquid is fed out to the static mixer 65 for performing the mixing enough. In the static mixer 65, the dissolution proceeds such that the mixture liquid may be the lower concentration dope. When the lower concentration dope is fed out from the static mixer 65, the temperature of the lower concentration dope is measured by a thermostat 66, and the measured value is sent to the controller 63. The controller 63 judges whether the temperature is the predetermined value. If the temperature is not the predetermined value, a signal is sent to the heating device 64 to change the heating conditions. Note that the heating devices 60,64 are preferably heat exchangers, and particularly preferably spiral heat exchanger. Thus the lower concentration dope is obtained from the mixture solvent in which the dissolution of the polymer is not enough. Therefore, the dissolution progresses even in the lower concentration dope even when the maximal value of the heating temperature is made lower to be 5° C. to 10° C. Therefore the denaturation of the solutes (especially polymer) is reduced.

The lower concentration dope is further fed to a filtration apparatus 67. Since the lower concentration dope has passed through two units (a unit of the heating device 60 and the static mixer 61 and a unit of the heating device 64 and the static mixer 65), the undissolved materials and the gel-like materials are extremely reduced.

After the lower concentration dope is fed through a pressure adjusting valve 68, the pressure of the lower concentration dope is measured by a pressure gauge 69, and the measured value is sent to the controller 63. The controller 63 judges whether the pressure P (MPa) of the lower concentration dope satisfies a condition:
2.0 MPa>P (MPa)≧(P0+(T−40)×A)MPa (1)
If this condition is not satisfied, the controller 63 sends a signal to the pressure adjusting valve 68, which opens and closes so as to control the pressure on the basis of the signal. Thereafter, the lower concentration dope is discharged from the flash pipe 27 into the flash tank 30 to make the enriching. Thereafter, a higher concentration dope 70 is fed out from the flash tank 30 by operating the pump 50. Thereafter, the processes are the same as in the dope preparation line 10.

If the temperature of the lower concentration dope is increased rapidly, the temperature control sometimes becomes harder. In order to prevent such case, as shown in FIG. 3, the plural heating devices (preferably heat exchangers) are used so as to increase the temperature gradually. Also in this case, it is preferable to provide the static mixer in a downstream side from each heating device, such that the static mixer and the heating device may construct a heat-mixing unit. Thus the temperature of each heating unit increases by at least 20° C. and at most 70° C. If the temperature does not increase by at least 20° C., it is necessary to provide a large number of the units, which makes the cost higher and the feeding time longer. In this case, although the heating is made at a low temperature, the composition of the solute (especially polymer) changes over time too much to be ignored. Further, if the temperature increases by more than 70° C., the temperature control sometimes becomes harder and the merits of providing many units are lost.

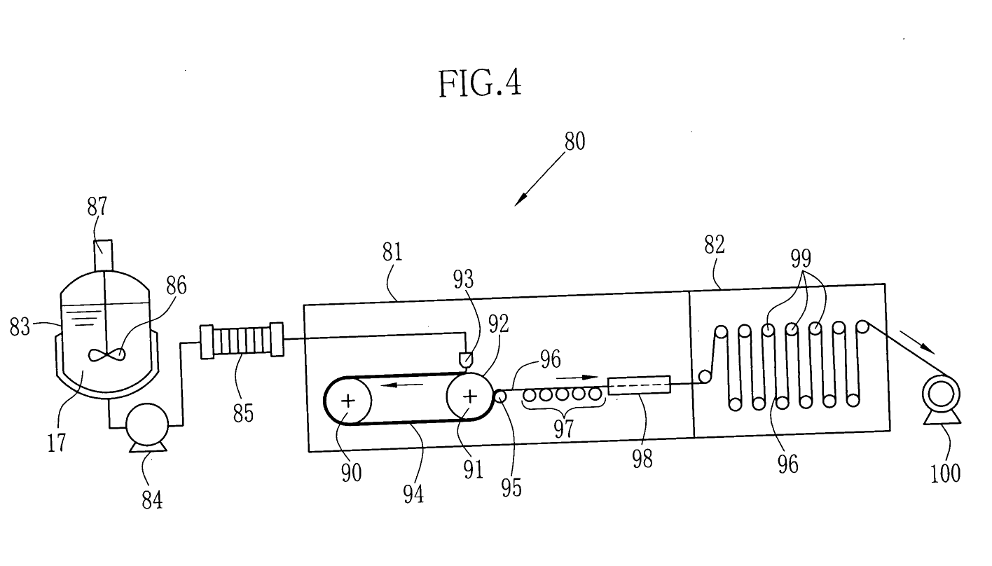

As shown in FIG. 4, a film production apparatus 80 is constructed of a belt zone 81 and a drying zone 82. A tank 83 for storing the higher concentration dope is connected through a pump 84 and a filtration apparatus 85 to the film production apparatus 80. The tank 83 includes stirrer blades 86, which is rotated by a motor to stir the higher concentration dope 17. Thus the concentration of the higher concentration dope 17 becomes uniform.

In the belt zone 81, a belt 92 is supported by support rollers 90,91, and a driver (not shown) rotates the support rollers 90,91 to move the belt 92 endlessly. Above the belt 92, a casting die 93 is disposed. The moving speed of the belt, namely the casting speed, is preferably in the range of 10 m/min to 200 m/min. Furthermore, in order to control the surface temperature of the belt 92 to a predetermined value, it is preferable to connect the support rollers 90,91 to a feeding device (not shown) for feeding the heat transfer medium. In this case, a passage of the heat transfer medium is provided in each support roller 90,91. The temperatures of the support rollers 90,91 are kept to the predetermined values by feeding the heat transfer medium into the passages. Thus the surface temperature of the belt 92 is controlled to the predetermined value. Note that the surface temperature of the belt 92 is preferably in the range of −20° C. to 40° C.

Preferably, the casting die 93 and the belt 92 is disposed in a casting chamber which includes a temperature controller for controlling the inner temperature of the casting chamber. The inner temperature is preferably in the range of −10° C. to 57° C. Preferably, the casting chamber is provided with a liquidizing device for liquidizing the vapor of the organic solvent, and the liquidized solvent is recovered into a recovering device and thereafter reused as the solvent for the dope preparation.

The higher concentration dope 17 is fed by the pump 84 from the tank 83 through the filtration apparatus 85 to the casting die 93. After the foreign materials are removed by the filtration apparatus 85, the casting die 93 casts the higher concentration dope 17 on the belt 92 to form a casting film 94. Note that a width of the casting film is preferably at least 1000 mm, and especially at least 1400 mm. Further, the casting is made with forming a bead of the dope discharged from the casting die 93 above the belt. The temperature of the dope to be cast is preferably at least −10° C. to 57° C. Further, in order to stably form the bead, a decompression unit is provided behind the bead so as to control the pressure around the bead from the upstream side of the belt. The casting film 94 is conveyed with the moving of the belt 92, and it is preferably to feed a drying air from an air blower concurrently so as to evaporate the organic solvent in the casting film 94. Preferably the air blower is disposed below the belt 92, or in an upstream or downstream side above the belt 92. However the position of the air blower is not restricted in it. Further, it is preferable to provide a wind shielding device for reducing the change of the surface condition of the casting surface in blowing air just after the casting. The belt 92 is preferably made of stainless, cupper and the like. Instead of the belt 92, a casting drum (rotary drum) can be used as a support. Preferably, the casting drum is preferably made of a stainless or cupper, and the hard chromium plating of thereof is made. In this case, the surface temperature of the casting drum is preferably from −20° C. to 40° C.

When having self-supporting properties, the casting film 94 is peeled as a film 96 from the belt 92 with support of a peeling roller 45, and thereafter fed toward a tenter device 98 in accordance with the rotation of rollers 97. Between the peeling roller 45 and the tenter device 98, an air blower (not shown) blows a drying air at a predetermined temperature so as to proceed the drying of the film 96. Preferably the predetermined temperature is from 20° C. to 250° C. Further, the rollers 97 in the downstream side preferably rotate faster than in the upstream side so as to draw the film 96. In the tenter device 98, both side edges of the film 96 are held by clips, which moves so as to draw the film in at least one of the widthwise direction and the lengthwise direction. Thus the drying of the film 96 is made at the same time, and the generation of the wrinkles and unevenness on the film surface is reduced. In this embodiment, the rollers 97 are positioned so as to contact only one surface of the film 96. However, the position of the rollers 97 is not restricted in the figure, and the rollers 97 may be positioned so as to contact both surface of the film 96.

Thereafter, both side edges of the film 96 are cut off by a cutter, and a cutter blower sent the cut side edges to a crasher for crashing the side edges into tips to be reused. Thus the cost becomes lower. Note that the process of cutting the both side edges can be omitted. However this process is performed preferably before winding the film, and especially before the drying zone 82.

The film 96 is fed to the drying zone 82 which includes plural rollers 99. The temperature of the drying zone 82 is not restricted especially. However, it is preferably in the range of 80° C. to 160° C. The film 96 to the drying zone 82 may be fed with use of the rollers 97 or the tenter device 98. However, as shown in FIG. 4, it is particularly preferable to use both of the rollers 97 and the tenter device 98 in which a direction of the drawing can be chosen. In the drying zone 82, the film 96 is fed with guide of the rollers 97 such that the organic solvent may evaporate. Thus the film 96 is dried. Preferably, the drying zone 82 is provided with a recovering device in which the adsorption of the solvent vapor is made for recovering the solvent. Further, the air from which the solvent vapor is removed is reused as the drying air to be blown into the drying zone. The drying zone 82 is preferably partitioned into plural parts such that the temperature may be independently controlled to be different between the partitions in each part. Further, if the temperature of the film increases rapidly, the shape of the film changes. Accordingly, it is preferable to provide a pre-drying chamber (not shown) for previously drying the film 96 between the cutter and the drying zone 82, so as to prevent the temperature of the film from increasing rapidly.

The film 96 is thereafter fed to a cooling chamber (not shown) for cooling to nearly a room temperature. Note that a moisture adjusting chamber may be provided between the drying zone and the cooling chamber. In the moisture adjusting chamber, an air whose moisture and temperature are adjusted is blown to the film 96 so as to reduce a winding defect in the film winding.

Preferably, a neutralization device (neutralization bar) is provided such that the charged electrical potential of the film 96 during the feeding may be in a predetermined range (for example −3 kV to +3 kV). Further, a knurling roller is provided for forming the knurling by emboss treatment on both side edges. The height of the protrusion an the depth of the retraction is preferably from 1 μm to 200 μm.

At last, the film 96 is wound by a winding apparatus 100. During the winding, it is preferable to apply a predetermined tension by a press roller. Preferably the tension is gradually carried from the start to the end of the winding. The length of the film 96 to be wound into a film roll is preferably at least 100 m. The width of film 96 to be wound is preferably at least 600 mm, and especially from 1400 mm to 1800 mm. However the present invention is also effective if the width is more than 1800 mm. Further the present invention can be applied when it is designated to produce the thin film having a thickness from 15 μm to 100 μm.

The film 96 is formed from the dope which is extremely uniform. Therefore, the film 96 is preferably used as a protective film for a polarizing filter, an optical compensation film, a film base of a photosensitive material, or the like. Especially, the polarizing filter and the optical compensation film are used in a liquid crystal display. Further, the present invention is especially effective when the width of the produced film is in the range of 1000 mm to 1800 mm, and effective even when the width is more than 1800 mm. Note the concentration of the higher concentration dope prepared by the preparation method of the dope of the present invention is preferably at least 60 wt. % in all of the doped to be used. In this case, the produced film is excellent in the optical properties.

In FIG. 4, the film producing apparatus 80 has the casting die 93 for forming a single layer. However, the solution casting method for forming the film is not restricted in forming the single layer. There are, for example, a co-casting method in which a casting die has a multi-manifold and a feed block is provided in an upstream side from the casting die, and a sequential casting method in which plural casting dies (they can be the casting dies for the co-casting) are disposed above the support so as to sequentially cast the dope. Further, at least one of the dope used in the co-casting method and the sequentially casting method can be prepared by the preparation method of the dope. It is especially preferable that the higher concentration dope prepared by the preparation method of the dope of the present invention is used for all of the dopes in the sequential or co-casting method.

The film produced by the co-casting method has plural layers. A thickness of each outermost layer of the film is preferably from 0.5% to 30% of the total thickness of the film. Furthermore, in the co-casting, it is preferable that a dope of low viscosity encompasses dopes of high viscosity when these dies are discharged through a slit from the casting die. Further, the dopes for forming outer layers preferably have a larger content of alcohol than the dope for forming the inner layers.

The Japanese Patent Application No. 2003-319673 discloses in detail the structure of the support, the casting die, the decompression chamber and the like, the conditions of the co-casting, the peeling, the drawing and each processing, the handling method, the curling method, the winding method after the correction of planarity, the recovering method of the solvent, and the recovering method of the film.

[Properties, Measuring Method]

The properties and the measuring method of the wound cellulose acylate film is disclosed in the application No. 2003-319673 in detail. This description can be applied to the present invention.

[Surface Treatment]

It is preferable to make a surface treatment of at least one surface of the cellulose acylate film. Preferably, the surface treatment is at least one of a glow discharge treatment in vacuum, a plasma discharge treatment under the atmospheric pressure, an irradiation of UV-ray, a corona discharge treatment, a flame treatment and an acid treatment.

[Functional Layer]

The primary coating may be made in at least one of the film surface of the cellulose acylate film. Further, when it is designated to use the cellulose acylate film as a base film, it is preferable to provide for a functional layer such that a functional material may be obtained. The functional layer is at least one of an antistatic layer, a cured resin layer, an antireflective layer, an adhesive layer, an antiglare layer and an optical compensation layer.

The functional layers preferably contain the surfactant in the range of 0.1 mg/m² to 1000 mg/m². Further, the functional layers preferably contain at least one sort of the lubricant in the range of 0.1 mg/m² to 1000 mg/m². Further, the functional layers preferably contain at least one sort of the matting agent in the range of 0.1 mg/m² to 1000 mg/m². Furthermore, the antistatic agent is preferably contained in the range of 1 mg/m² to 1000 mg/m². The method of forming the functional layer of the surface treatment so as to provide the several functions. The application No. 2003-319673 discloses other conditions and methods for forming the functional layers of the surface treatment.

The cellulose acylate film can be used as a protective film for the polarizing filter. In the polarizing filter, two cellulose acylate films are adhered to the liquid crystal member. Note that the positional relation is not restricted especially, and described, for example, as TV type, STN type, VA type, OCB type, reflective type, and other example in detail in the application No. 2003-319673. These types can be applied to the present invention. Further, this publication discloses the cellulose acylate film in which an optical anisotropic layer is provided, or the cellulose acylate film in which an antireflective layer and an antiglare layer are provided. Further, the publication discloses that a bi-axial cellulose acylate film provided with adequate optical properties is used as the optical functional film with the protective film for the polarizing filter. The restriction of use of the cellulose acylate film is described in the application No. 2003-319673.

### Embodiment 1

In Embodiment 1, the dope was prepared of the preparation method of the present invention with use of the dichloromethane type mixture solvent. The preparation of the higher concentration dope was made with use of the dope preparation line 10. Dichloromethane and an alcohol mixture (mixture ratio, (methanol):(1-butanol)=95:5 (composition ratio or weight ratio) were mixed at the mixture ratio of 83:17 (weight ratio). Further, the degree of acetylation of the used TAC was 61.0%. The plasticizer was the mixture of TPP and BDP at the weight ratio 2:1. They were supplied into the mixing tank 11 such that the polymer concentration might be 19.0 wt. %. The motor of power at 45 kW is driven to rotate the motor at 80 rpm of the rotational number. Thus the stirring was made for 50 minutes to obtain the mixture liquid 14. The heating device 20 was a spiral heat-exchanger (produced by Kurose Chemical Equipment Co., Ltd.). Further, the inner diameter D1 of the static mixer 21 was 100 mm, and the number of the blades 21a was 18. The heat transfer medium of the heating device 20 was water vapor.

The flow rate of the mixture liquid 14 fed by the pump 15 was 70 L/min, and further fed through the heating device 20 and the static mixer 21. Thus the lower concentration dope was obtained, and the temperature thereof was measured by the thermometer 22. The feed conditions of the heat transfer medium of the heating device 20 was adjusted so as to control the temperature of the lower concentration dope in the range of 88° C. to 92° C. Then the pressure of the lower concentration dope was measured by the pressure gauge 26, and the data of the measurement was sent to the controller 23 so as to open and close the pressure adjusting valve 25. The highest temperature T of the dope during the heating was 91° C., and the pressure P was controlled in the range of 1.3 MPa±0.2 MPa. Then the lower concentration dope 16 was fed thought the flash pipe 27 so as to discharge into the flash tank 30.

Between the flash tank 30 and the jacket 35, a warm water at 35° C. was supplied as the heat transfer medium 36 (see, FIG. 2). Further, the capacity V of the flash tank 30 was 7 m³, and the amount of the higher concentration dope 17 stored in the flash tank 30 was controlled such that the ratio of the liquid phase volume Vl to the gas phase volume Vg might be 4:1. The stirrer blades 32 were the inclined paddle type, and rotated at 15 rpm. The height L1 from the tope of the stirrer blade 32a and the liquid surface 17a was in the range of 200 mm±200 mm, and the height L2 from the front end 27a of the flash pipe 27 and the liquid surface 17a was 500 mm±200 mm. Furthermore, the height L3 from the entrance end 38a to the liquid surface 17a was 600 mm±200 mm. The cooling temperature of the liquidizing device 37 was 7° C.±5° C.

Part of the lower concentration dope 16 becomes solvent vapor, which is liquidized in the liquidizing device 37 so as to recover the solvent. The recovery solvent is reused as the solvent for preparing a lower concentration dope 16. The polymer concentration of the higher concentration dope 17 was measured by the oven dry weight, and the measured value was 23 wt. %. The higher concentration dope 17 was extracted at the flow rate of 50 L/min with use of the pump 50.

The temperature controller 51 was the spiral heat exchanger. The heat transfer medium for the temperature controller 51 was the warm water at 35° C. Further, the inner diameter of the static mixer 52 was 100 mm, and the number of the blades was 6. The filter materials of the filtration apparatus 53 was formed of sintered metal and had nominal pore diameter of 10 μm.

After fed through the filtration apparatus 53, the higher concentration dope 17 was used in the solution casting method for the film production. The film production was made with use of the film production apparatus 80 as shown in FIG. 4. The higher concentration dope 17 was supplied in the tank 83, and the stirrer blades 86 were rotated so as to keep the higher concentration dope 17 uniform.

The higher concentration dope 17 was fed to the casting die 93 with use of the pump 84, and cast onto the belt 92 from the casting die 93 to form the casting film 94 such that the film thickness after the drying might be 80 μm. The width of the casting film was 2000 mm. The temperature of the belt 92 was controlled by the temperature controller (not shown) to be about 25° C. When the casting film had the self-supporting properties, the casting film was peeled as the film 96 with support of a peeling roller 95. The rotational speed of each roller 97 was adjusted to draw the film 96 such that the length of the film 96 might be 10% larger. Thereafter, the film 96 was transported into the tenter device 98 whose temperature was kept at 140° C. Then the film 96 was transported in the tenter device 98 for 0.5 minutes to proceed the drying, and the film was drawn in the widthwise direction so as to be 20% larger. Thereafter, the film 96 was transported into the drying zone 82 whose temperature was controlled in the range of 120° C. to 145° C. In the drying zone 82, the film 96 was transported with guide of the rollers 99 for 10 minutes. Thereafter the film 96 was wound.

The retardation Re on surface and the retardation (Rth) in thickness of the film 96 to a light of 632.8 nm wavelength was measured with an ellipsometer. The retardations Re and Rth were 3 nm and 40 nm, respectively. Thus the produced film is excellent in the optical properties.

The preparation method of the dope of the present invention can be applied when it is designated that the hardly soluble solute is dissolved to the solvent to obtain the solution.

### Embodiment 2

In followings, an explanation for Embodiment 2 will be made. Note that the same explanation as Embodiment 1 will be omitted. The dope preparation line illustrated in FIG. 3 was used for the preparing the higher concentration dope. At first, the lower concentration dope whose polymer concentration might be 19.0 wt % was prepared from TAC, the mixture solvent, and the plasticizer. The lower concentration dope was supplied into a mixing tank 11 and then stirred such that the mixture liquid 14 was obtained. The mixture liquid was fed by driving the pump 15. Thus the mixture liquid sequentially passed through the heating device 60 (in this embodiment, the spiral heat exchanger) and the static mixer. Then temperature of the mixture liquid was measured by the thermometer 62, and then the supplying conditions of the transmitting mediums into the spiral heat exchanger was adjusted such that the temperature of the mixture liquid 14 might be in the range of 48° C. to 50° C.

Then the mixture liquid was fed to the heating device 64 and then to the lower concentration dope. Thereafter the temperature of the lower concentration dope was measured by the thermometer 66, and then the supplying conditions of the transmitting mediums into the spiral heat exchanger was adjusted such that the temperature of the mixture liquid 14 might be in the range of 83° C. to 85° C. In Embodiment 2, the lower concentration dope is obtained from the mixture solvent in which the dissolution of the polymer is not enough. Therefore, the dissolution progresses even in the lower concentration dope even when the maximal value of the heating temperature is made lower to be about 5° C. In followings, after the flush evaporation of the lower concentration dope was made under the same conditions as Embodiment 1, the film was produced. Thus the optical properties of the obtained film were excellent, similarly to Embodiment 1.

Various changes and modifications are possible in the present invention and may be understood to be within the present invention.

1. A preparation method of a polymer solution containing a polymer and a solvent, comprising steps of:
dissolving said polymer to said solvent with a heating, so as to obtain a dilute polymer solution whose polymer concentration is in the range of 15 wt. % to 20 wt. %;
filtrating said dilute polymer solution, said polymer concentration of said dilute polymer solution being reduced by the filtration in the range of ±1 wt. % from a predetermined concentration such that a polymer concentration of said polymer solution might be regulated in the range of ±1 wt. % from a predetermined concentration;
enriching said dilute polymer solution so as to obtain a polymer solution, said polymer concentration of said polymer solution being in the range of 20 wt. % to 30 wt. %.

2. A preparation method claimed in claim 1, further comprising filtrating said polymer solution.

3. A preparation method claimed in claim 1, wherein the heating is made by a heat exchanger, and a static mixer for stirring said dilute polymer solution is disposed downstream from said heat exchanger before the filtration is made.

4. A preparation method claimed in claim 1, wherein said polymer solution is used for producing a polymer film.

5. A preparation method of a polymer solution containing a polymer and a solvent, comprising steps of:
dissolving said polymer to said solvent with a heating at a temperature equal to or more than a boiling point of said solvent, so as to obtain a dilute polymer solution whose polymer concentration is in the range of 15 wt. % to 20 wt. %;
supplying said dilute polymer solution into a vessel in which a pressure is controlled to an atmospheric pressure ±0.01 MPa; and
enriching said dilute polymer solution so as to obtain a polymer solution, a polymer concentration of said polymer solution being in the range of 20 wt. % to 30 wt. %.

6. A preparation method claimed in claim 5, further comprising a step of:
stirring said dilute polymer solution with stirrer blades provided in said vessel, a height L1 (mm) from a top of each of said stirrer blades to a liquid surface of said dilute polymer solution being at most 800 mm.

7. A preparation method claimed in claim 6, wherein a rotary speed of said stirrer blades is from 2.5 rpm to 25 rpm.

8. A preparation method claimed in claim 5, wherein said tank is provided with a pipe for supplying said dilute polymer solution therein, and a height L2 (mm) from a liquid surface of said dilute polymer solution to an exit of said pipe is in the range of 100 mm to 1000 mm.

9. A preparation method claimed in claim 5, wherein a heating unit is constructed of said heat exchanger and said static mixer disposed in downstream from said heat exchanger, a number of said heating unit is at least 2, and a temperature of said dilute polymer solution in each of said static mixer is increased by at least 20° C. and at most 70° C.

10. A preparation method claimed in claim 9, wherein said vessel is connected through a pipe to a liquidizing device for liquidizing said solvent vapor with aspirating said solvent vapor, and a height L3 (mm) from said liquid surface of said dilute polymer solution to an entrance of said pipe is in the range of 200 mm to 1000 mm.

11. A preparation method claimed in claim 5, wherein a temperature of said dilute polymer solution in said vessel is kept to a predetermined value in the range of 30° C. to 40° C.

12. A preparation method claimed in claim 5,
wherein a temperature T (° C.) of said dilute polymer solution before supplied to said tank is in the range of 60° C. to 120° C.,
wherein when a theoretical value of vapor pressure at said temperature T is P0 (MPa) and a coefficient corresponding to a sort of said solvent is A (MPa/° C.), a pressure P (MPa) of said dilute polymer solution to be supplied to said tank is controlled so as to satisfy a formula,
2.0 MPa>P (MPa)≧(P0+(T−40)×A)MPa.

13. A preparation method claimed in claim 5, wherein the heating is made by a heat exchanger, and a static mixer for stirring said dilute polymer solution is disposed downstream from said heat exchanger.

14. A preparation method claimed in claim 5, wherein a heat exchanger is disposed downstream from said vessel, and a temperature of a heat transfer medium of said heat exchanger is in the range of 30° C. to 40° C.

15. A preparation method claimed in claim 5, a filtration apparatus for filtrating said polymer solution is disposed downstream from said vessel, and includes a filter whose nominal pore diameter is from 3 μm to 100 μm.

16. A preparation method claimed in claim 5, wherein a polymer film is produced from said polymer solution.

17. A preparation method of a polymer solution, comprising steps of:
dissolving said polymer to said solvent with heating at a temperature equal to or more than a boiling point of said solvent by a heat exchanger, so as to obtain a dilute polymer solution whose polymer concentration is in the range of 15 wt. % to 20 wt. %;
stirring said dilute polymer solution with use of a static mixer; and
enriching said dilute polymer solution so as to obtain a polymer solution, a polymer concentration of said polymer solution being in the range of 20 wt. % to 30 wt. %.

18. A preparation method claimed in claim 17, wherein a heating unit is constructed of said heat exchanger and said static mixer disposed in downstream from said heat exchanger, a number of said heating unit is at least 2, and a temperature of said dilute polymer solution in each of said static mixer is increased by at least 20° C. and at most 70° C.

19. A preparation method claimed in claim 17, wherein a temperature of said dilute polymer solution is measured with a thermometer provided downstream from said static mixer, and a temperature control of said heat exchanger is made on the basis of a result of the measurement.

20. A preparation method claimed in claim 17,
wherein a flow rate of said dilute polymer solution to be fed to said static mixer is from 30 L/min to 150 L/min,
wherein an inner diameter of a pipe of said static mixer is from 50 mm to 200 mm, and
wherein a number of skirt provided in said static mixer is from 4 to 20.

21. A preparation method claimed in claim 17, wherein said heat exchanger is a spiral heat exchanger.

22. A preparation method claimed in claim 17, wherein said polymer solution is used for producing a polymer film.
